(19) United States
(12) Patent Application Publication
(10) Pub. No.: US 2026/0327956 A1
(43) Pub. Date: Oct. 22, 2026

(54) HYDRAULIC HEALTH MONITORING SYSTEM

(71) Applicant: Caterpillar Inc., Peoria, IL (US)

(72) Inventors: Richard Andrew Carpenter, Chillicothe, IL (US); Wajahat Afsar, Dunlap, IL (US); Aravind Stalin, Peoria, IL (US); Vinay Kumar Rao Veeramaneni, Peoria, IL (US); Rodrigo Vargas Belman, Monterrey City (MX)

(73) Assignee: Caterpillar Inc., Peoria, IL (US)

(21) Appl. No.: 19/183,341

(22) Filed: Apr. 18, 2025

(51) Int. Cl. E02F 9/26; E02F 9/22

(52) U.S. Cl. CPC E02F 9/267; E02F 9/2203; E02F 9/225; E02F 9/264; E02F 9/2285; E02F 9/2292

(57) ABSTRACT

A hydraulic health monitoring system for a machine may include an engine, a steering column, an implement, a pump and/or a motor. A plurality of sensors and a controller are configured to receive real-time operational data from the engine, a steering hydraulic system, an implement hydraulic system, and a hydrostatic system. The plurality of sensors includes a temperature sensor, a pressure sensor, a position sensor, and a speed sensor. The controller determines whether conditions for enabling hydraulic efficiency calculations are satisfied, calculates a volumetric efficiency value for one or more of the hydraulic systems based on detected cylinder actuator position changes and a pump flow rate derived from engine speed and pump displacement, and compares one or more calculated volumetric efficiency values to a corresponding efficiency threshold. A system diagnostic output is generated when the volumetric efficiencies of any hydraulic system falls below the efficiency threshold.

### TECHNICAL FIELD

The present disclosure generally relates to hydraulic systems in work machines, and more particularly to systems for monitoring hydraulic efficiency and performance in work machines.

### BACKGROUND

Hydraulic systems are widely used in various industrial applications, including construction, mining, and agriculture. These systems rely on pressurized fluid (“hydraulic fluid”, “oil”, “hydraulic oil” used interchangeably throughout) to transfer energy for performing mechanical tasks, such as lifting, steering, and propulsion. Many modern machines, including earth-moving equipment, material handlers, and industrial vehicles, use hydraulic actuators, pumps, valves, and motors to operate essential components efficiently. Monitoring the health and performance of these hydraulic components is crucial for ensuring reliable operation, reducing downtime, and minimizing maintenance costs

In many cases, efficiency losses in hydraulic systems can result from component wear, fluid degradation, pressure fluctuations, or improper system calibration. Identifying these issues early is essential to prevent equipment failure and productivity loss. Various solutions have been proposed to improve hydraulic system monitoring, including the use of sensor-based diagnostics and performance tracking.

U.S. Pat. No. 9,051,945 describes a system for monitoring hydraulic pump performance by detecting volumetric efficiency loss and impending failures using pressure and displacement sensors. While this system provides some predictive capabilities, it primarily focuses on volumetric deficiencies in multi-hydrostatic systems and lacks broader real-time diagnostics for comprehensive hydraulic efficiency assessment. Moreover, it does not fully address dynamic operating conditions, or adaptive failure prevention strategies that are critical for ensuring optimal hydraulic performance across a variety of machine types.

It can therefore be seen that a need exists for an improved hydraulic monitoring system that provides enhanced diagnostic capabilities, broader efficiency evaluation beyond volumetric losses, and improved adaptability to diverse operating conditions.

### SUMMARY

In accordance with one aspect of the disclosure, a hydraulic health monitoring system for a machine is provided. The machine comprises an engine, an implement, an implement control actuator for operating the implement, and ground-engaging elements propelled by the engine. The hydraulic health monitoring system includes a plurality of sensors and a controller connected to the plurality of sensors. The controller is configured to receive real-time operational data from one or more of the plurality of sensors associated with the engine, a steering hydraulic system, an implement hydraulic system, and a hydrostatic system. The plurality of sensors comprises at least one temperature sensor configured to detect hydraulic fluid temperature, at least one pressure sensor configured to detect hydraulic fluid pressure, at least one position sensor configured to detect actuator positions, and at least one speed sensor configured to detect engine speed. The controller determines whether predefined conditions for enabling hydraulic efficiency calculations are satisfied, the predefined conditions including at least hydraulic fluid temperature, hydraulic fluid pressure, and machine speed conditions. Upon satisfying the predefined conditions, the controller calculates a volumetric efficiency value for one or more of the steering hydraulic system, the implement hydraulic system, and the hydrostatic system by determining an actual hydraulic flow rate based on detected cylinder actuator position changes and comparing it to a pump flow rate based on engine speed and hydraulic pump displacement. The controller compares one or more of the calculated volumetric efficiency values to a corresponding efficiency threshold for the respective hydraulic system and generates one or more of a system diagnostic output when the volumetric efficiencies of the steering hydraulic system, the implement hydraulic system, or the hydrostatic system fall below the corresponding efficiency threshold.

In accordance with another aspect of the disclosure, a work machine is provided. The work machine comprises a frame, an engine mounted on the frame, and ground-engaging elements supporting the frame. The work machine further includes a hydraulic health monitoring system configured to receive real-time operational data via a controller from one or more of a plurality of sensors associated with the engine, a steering hydraulic system, an implement hydraulic system, and a propulsion hydraulic system. The plurality of sensors comprises at least one temperature sensor configured to detect hydraulic fluid temperature, at least one pressure sensor configured to detect hydraulic fluid pressure, at least one position sensor configured to detect cylinder actuator position changes, and at least one speed sensor configured to detect engine speed. The controller determines whether predefined conditions for enabling hydraulic efficiency calculations are satisfied, wherein the predefined conditions include at least hydraulic fluid temperature, hydraulic fluid pressure, and machine speed conditions. The controller calculates a volumetric efficiency value for each of the steering hydraulic system, the implement hydraulic system, and the propulsion hydraulic system by determining an actual hydraulic flow rate based on detected cylinder actuator position changes and comparing it to a pump flow rate derived from engine speed and hydraulic pump displacement. The controller compares one or more of the calculated volumetric efficiency values to a corresponding efficiency threshold for the respective hydraulic system and generates one or more of a system diagnostic output when the volumetric efficiencies of the steering hydraulic system, the implement hydraulic system, or the propulsion hydraulic system fall below the corresponding efficiency threshold.

In accordance with another aspect of the disclosure, a method for monitoring the health of hydraulic systems in a machine is provided. The machine comprises an engine, a steering hydraulic system, an implement control actuator for operating an implement, and an implement hydraulic system. The method includes receiving real-time operational data via a controller from one or more of a plurality of sensors associated with the engine, the steering hydraulic system, the implement hydraulic system, and the propulsion hydraulic system. The plurality of sensors includes at least one temperature sensor configured to detect hydraulic fluid temperature, at least one pressure sensor configured to detect hydraulic fluid pressure, at least one position sensor configured to detect actuator positions, and at least one speed sensor configured to detect engine speed. The method further includes determining whether predefined conditions for enabling hydraulic efficiency calculations are satisfied, the predefined conditions including at least hydraulic fluid temperature, hydraulic fluid pressure, and machine speed conditions. Upon satisfying the predefined conditions, the controller calculates a volumetric efficiency value for each of the steering hydraulic system, the implement hydraulic system, and the propulsion hydraulic system by determining an actual hydraulic flow rate based on detected cylinder actuator position changes and a pump flow rate based on engine speed and hydraulic pump displacement. The controller then compares one or more of the calculated volumetric efficiency values to a corresponding efficiency threshold for the respective hydraulic system and generates one or more of a system diagnostic output when the volumetric efficiencies of the steering hydraulic system, the implement hydraulic system, or any other hydraulic system of the machine fall below the corresponding efficiency threshold.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a machine, according to an embodiment of the present disclosure.

FIG. 2 is a block diagram of a control system of the machine of FIG. 1, accordingly to an embodiment of the disclosure.

FIG. 3 is a perspective view of a steering column of the machine of FIG. 1, according to an embodiment of the present disclosure.

FIG. 4 is a perspective view of a work implement on the machine of FIG. 1, according to an embodiment of the present disclosure.

FIG. 5 is a block diagram of a hydraulic monitoring system of the machine of FIG. 1, according to an embodiment of the present disclosure.

FIG. 6 is a block diagram of a hydraulic monitoring system of the machine of FIG. 1, according to another embodiment of the present disclosure.

FIG. 7 is a schematic of a multi-hydraulic circuit monitored by the hydraulic monitoring system of FIG. 5, according to an embodiment of the present disclosure.

FIG. 8 is a schematic of a multi-hydraulic implement circuit monitored by the hydraulic monitoring system of FIG. 5, according to an embodiment of the present disclosure.

FIG. 9 is an exemplary graph of a system efficiency issue identified by the hydraulic monitoring system of FIG. 5, according to an embodiment of the present disclosure.

FIG. 10 is an exemplary graph of a pump efficiency failure identified by the hydraulic monitoring system of FIG. 5, according to an embodiment of the present disclosure.

FIG. 11 is an operation flowchart of the hydraulic monitoring system of FIG. 5, according to an embodiment of the present disclosure.

FIG. 12 is a schematic of a multi-hydraulic pump circuit monitored by the hydraulic monitoring system of FIG. 6 in a hystat propulsion system in the machine of FIG. 1, according to another embodiment of the disclosure.

FIG. 13 is a schematic of a left-hand motor monitored by the hydraulic monitoring system of FIG. 6 in a hystat propulsion system in the machine of FIG. 1, according to an embodiment of the disclosure.

FIG. 14 is a schematic of a right-hand motor monitored by the hydraulic monitoring system of FIG. 6 in a hystat propulsion system in the machine of FIG. 1, according to an embodiment of the disclosure.

FIG. 15 is an exemplary graph of a system efficiency issue identified by the hydraulic monitoring system of FIG. 6, according to an embodiment of the disclosure.

FIG. 16 is an exemplary graph of a pump efficiency failure identified by the hydraulic monitoring system of FIG. 6, according to an embodiment of the disclosure.

FIG. 17 is an operation flowchart of the hydraulic monitoring system of FIG. 6, according to another embodiment of the disclosure.

FIG. 18 is a flow chart of a method of monitoring the health of hydraulic systems that have a pump, valve, and cylinder in the machine of FIG. 1, according to an embodiment of the present disclosure.

FIG. 19 is a flow chart of a method of monitoring the health of hydraulic systems that have a pump and motor in the machine of FIG. 1, according to an embodiment of the present disclosure.

The figures depict embodiments of the presented invention for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a machine 100 is shown, illustrated as an exemplary wheel loader. Wheel loaders are heavy equipment designed to move earth material from the ground or landscape at a dig site in the construction and agricultural industries. While the following detailed description describes an exemplary aspect in connection with the excavator, it should be appreciated that the description applies equally to the use of the present disclosure in other machines, including, but not limited to, excavators, backhoes, front-end loaders, shovels, draglines, skid steers, and tractors, as well.

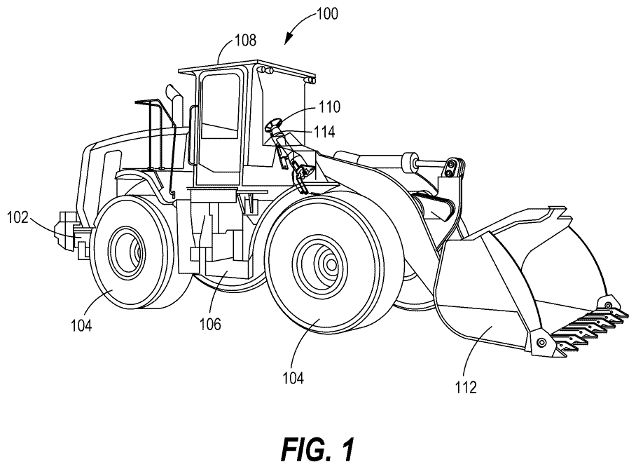

Referring now to FIG. 1, the machine 100 comprises a frame 102. The frame 102 is supported on ground engaging elements 104, illustrated as wheels. It should be contemplated that the ground engaging elements 104 may be any other type of ground engaging elements 104 such as, for example, continuous tracks, etc. The machine 100 further includes an engine 106 in the frame 102 for power and propulsion, as generally known in the arts, and a cab 108 for operator personnel to operate the machine 100. The frame 102 may have an upper swiveling body common with excavators and machines in the construction and agricultural industries. The cab 108 may be rotatable on the frame 102 or rotatable via the upper swiveling body common with excavators and other machines in the construction and agricultural industries. The engine 106 may be any prime mover such as combustion engine or electric motor, as generally known in the arts.

The machine 100 further includes a steering column 110 positioned within the cab 108. The steering column 110 is operatively connected to a steering system that includes a hydraulic steering actuator, allowing an operator to control the movement of the machine 100. The steering system facilitates precise maneuverability, essential for various operational conditions.

The machine 100 includes an implement 112 extending from the frame 102 for conducting work, such as, for example, excavating landscapes or otherwise moving earth, soil, or other material at a dig site. The machine 100 is further equipped with an implement control actuator 114, which controls the movement of the implement 112. The implement control actuator 114 enables lifting, tilting, or otherwise manipulating the implement 112 to perform a variety of functions depending on the machine's application.

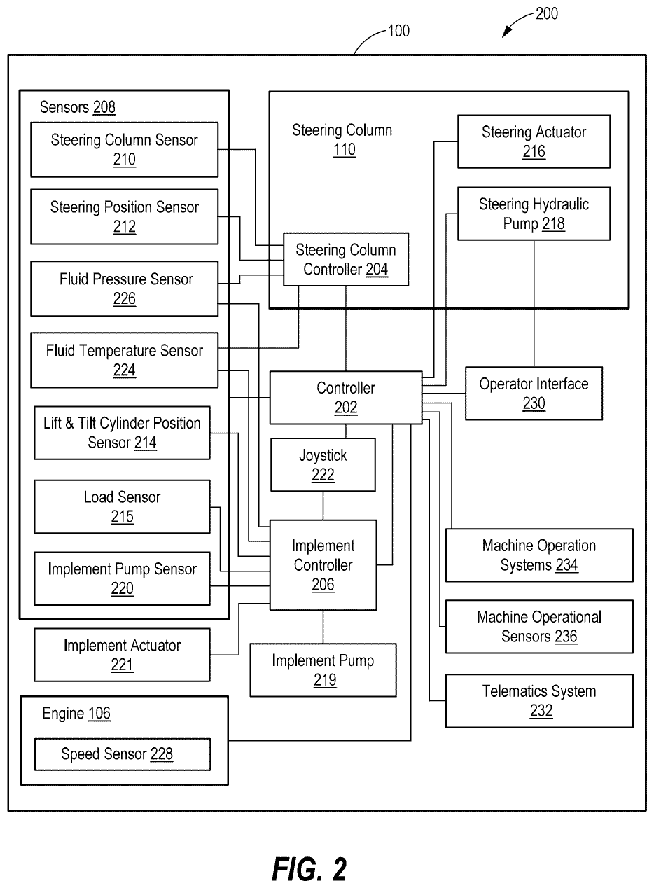

Now referring to FIG. 2, FIG. 2 a block diagram of a control system 200 of the machine 100 of FIG. 1 is illustrated, accordingly to an embodiment of the disclosure. The control system 200 is provided for managing and monitoring various operational parameters of the machine 100. The control system 200 comprises a controller 202, which is communicatively connected to a plurality of subsystems to ensure efficient operation and diagnostic capabilities of the machine 100, the steering column 110, and the implement 112. The control system 200 includes a steering system controller 204 for governing steering-related functions and an implement controller 206 for managing the implement 112.

The control system 200 further includes a plurality of sensors 208 that provide real-time feedback regarding system performance. The plurality of sensors 208 include steering column sensors 210 for monitoring the steering input, a steering position sensor 212 for detecting the angle of the steering wheel, and a lift & tilt cylinder position sensor 214 for determining the position of the hydraulic cylinders provided in the steering column 110 and/or implement 112 for controlling the steering column 110 and/or implement 112. The lift & tilt cylinder position sensor 214 detects the instantaneous position of the hydraulic cylinders, and the controller 202 compares sequential position readings to determine the magnitude and direction of actuator movement, enabling assessment of hydraulic system operation.

The steering column 110 includes a steering actuator 216, which responds to commands from the steering system controller 204, enabling hydraulic movement of the steering column 110. The steering hydraulic pump 218 provides pressurized fluid to facilitate steering adjustments. The system ensures smooth and responsive maneuverability, allowing operators to maintain control even in challenging terrain or heavy-load scenarios.

Additional sensors include a fluid temperature sensor 224 provided in the steering column 110 and/or implement 112 for measuring hydraulic fluid conditions, and a fluid pressure sensor 226 provided in the steering column 110 and/or implement 112 for detecting hydraulic system pressure. A speed sensor 228 may be provided in the engine 106 for monitoring machine speed, and additional speed sensors 228 may be provided elsewhere.

The control system 200 also comprises an operator interface 230 for displaying system diagnostics, real-time operational parameters, and control selections for an operator. A telematics system 232 is provided for facilitating remote monitoring and data transmission, allowing for predictive maintenance and enhanced fleet management.

The control system 200 is communicatively connected to machine operational systems 234 and machine operation sensors 236 to ensure efficient operation and diagnostic capabilities of the machine 100, the steering column 110, and the implement 112. The machine operational systems 234 such as propulsion systems, cooling systems, and other subsystems generally found in a machine 100 and machine operation sensors 236 collectively support system diagnostics, ensuring optimal machine performance and reliability.

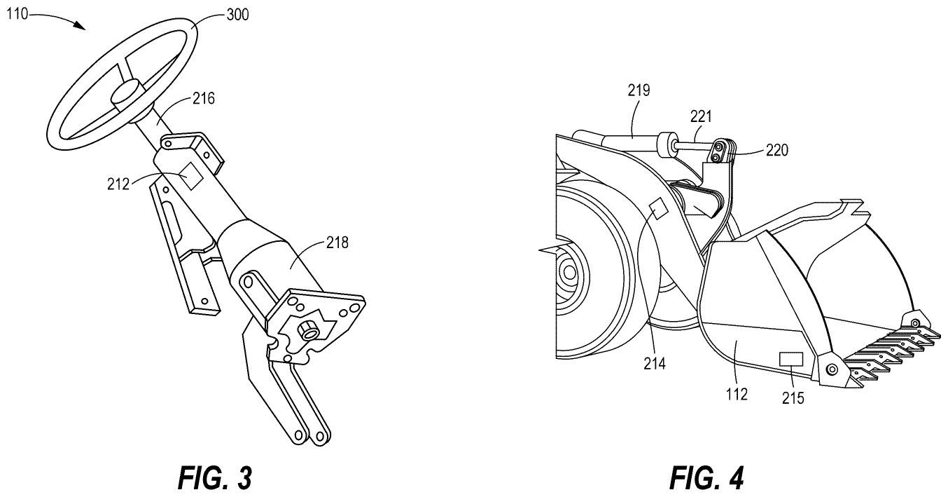

Referring now to FIG. 3, a perspective view of the steering column 110 of machine 100 of FIG. 1 is illustrated, according to an embodiment of the present disclosure. The steering column 110 includes a steering wheel 300, which is manually operated by an operator to control the steering function. The steering system controller 204 receives input from steering column sensors 210 and a steering position sensor 212, which detect angular displacement and operator intent. While the steering position sensor 212 identifies the angular position of the steering wheel, it is through continuous monitoring that the controller 202 interprets positional changes to evaluate steering response and operator input accuracy.

Now referring to FIG. 4, a perspective view of the implement 112 of machine 100 of FIG. 1 is illustrated, according to an embodiment of the present disclosure. The implement 112 is connected to the machine 100 via an implement control actuator 114, which enables controlled movement. The implement sensors 214 may detect positioning and load conditions, ensuring optimal performance during operation.

The implement pump sensor 220 provides real-time feedback on hydraulic pressure levels within the implement system. A joystick 222, which may be provided as the implement control actuator 114, is provided in the cab 108 to allow for manual adjustments of the implement 112 by an operator. The implement hydraulic pump 219 supplies hydraulic fluid to the actuators, ensuring precise motion control. A load sensor 215 is configured to detect force exerted on the implement 112, allowing for efficiency calculations and predictive maintenance measures. The load sensor 215 may be further configured to transmit real-time force data to the controller 202, enabling adjustment of hydraulic flow parameters and enhancing the accuracy of system diagnostics under varying load conditions.

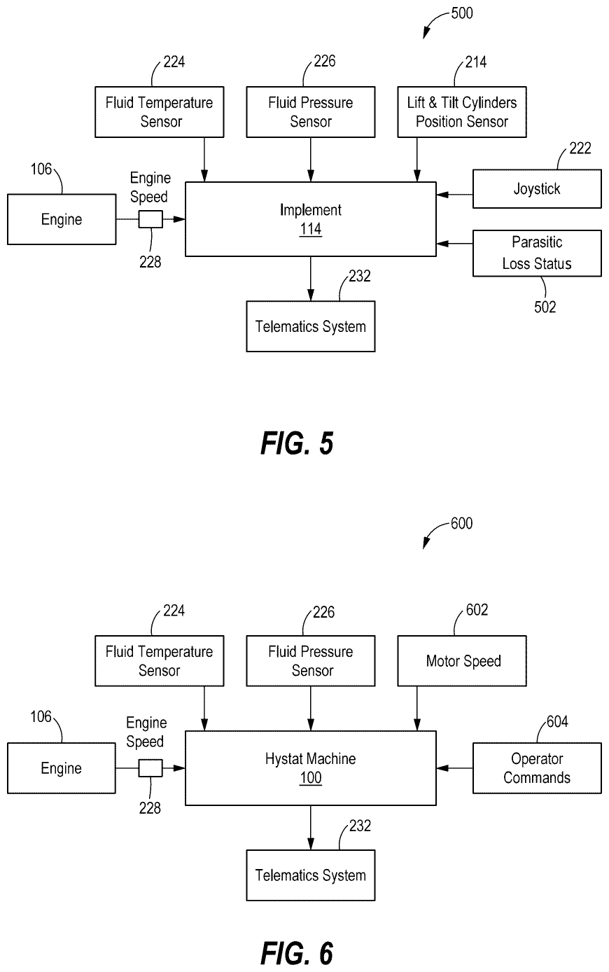

Referring now to FIG. 5, a block diagram of a hydraulic monitoring system 500 for the machine 100 is illustrated, according to an embodiment of the present disclosure. FIG. 5 illustrates the data acquisition communicated to the controller 202 in the machine 100 to assess the efficiency of the hydraulic system in real-time, ensuring optimal operation and detecting potential failures. The hydraulic monitoring system 500 monitors the engine speed, the hydraulic fluid temperature, implement pump sensor, lift & tilt cylinder positions, and lift lever and tilt lever positions via a joystick for monitoring the health of the hydraulic systems that have a pump, a valve, and a cylinder such as the steering column 110 and the implement 112.

The plurality of sensors 208 collect operational parameters related to either the steering column 110 and the implement 112. The steering column 110 includes steering column sensors 210, steering position sensor 212, and steering hydraulic pump 218, which transmit data to the steering column controller 204 for processing. The hydraulic monitoring system 500 verifies a status of whether a parasitic loss 502 exists, determining whether the steering operations of the machine 100 and/or implement are engaged in normal or dampened control modes. If valid steering conditions are met, the control system evaluates the steering actuator 216 and joystick 222 efficiency by analyzing hydraulic flow, pressure levels, and operator inputs. If the efficiency of the steering actuator 216 and/or joystick 222 falls below an acceptable threshold, the hydraulic monitoring system 500 generates an alert signal to notify the operator via the operator interface 230 and/or logs the event through telematics system 232 for remote diagnostics. The controller 202 evaluates steering system efficiency by analyzing data from the steering position sensor 212 and steering column sensors 210 to track changes in steering input position and actuator response over time. These position changes, combined with pressure and flow metrics, enable calculation of steering hydraulic performance.

The implement 112 is also assessed, where the implement controller 206 collects data from the joystick 222 or the implement control actuator 114 and the implement sensors such as the implement pump sensor 220, load sensor 215 and the lift & tilt cylinder position sensor 214. The lift & tilt cylinder position sensor 214 detects the positions of the implement actuators, and the controller 202 determines actuator movement by comparing consecutive position readings. This calculated actuator displacement is used to derive actual hydraulic flow, which is then compared to expected values based on implement pump sensor 220 and speed sensor 228 inputs for accurate volumetric efficiency assessment. The implement system receives hydraulic power from the engine 106, as represented by the flow of hydraulic fluid to the implement pump 219. The control system 200 determines whether the machine 100 is operating within operating conditions to ensure valid efficiency calculations. If the operating conditions meet predefined thresholds, the control system calculates the volumetric efficiency of the hydraulic system by comparing actual hydraulic flow to expected values based on implement hydraulic pump 219 displacement and speed sensor 228 readings. The hydraulic monitoring system 500 transmits this efficiency data to the telematics system 232 for real-time monitoring and predictive analysis.

The computed efficiency value is compared to a predefined efficiency threshold. If the efficiency remains within acceptable limits, the hydraulic monitoring system 500 continues normal operation. However, if the efficiency drops below the threshold, the control system 200 generates a failure notification through the operator interface 230 or transmits a diagnostic alert via telematics system 232 to enable predictive maintenance and prevent potential failures. The telematics system 232 can further transmit efficiency trends to a remote monitoring system for fleet-wide analysis.

Referring now to FIG. 6, a block diagram of a hydraulic monitoring system 600 is illustrated, according to another embodiment of the present disclosure. FIG. 6 illustrates the hydraulic monitoring system 600 configured to evaluate the volumetric efficiency of a hydrostatic propulsion system provided in the machine 100. The hydrostatic propulsion system includes at least one hydraulic pump, such as the implement hydraulic pump 219, fluidly connected to a pair of hydraulic motors, such as a left-hand motor 1300 and a right-hand motor 1400, which drive respective ground engaging elements 104 of the machine 100. The hydraulic monitoring system 600 acquires data from a plurality of sensors 208 for monitoring real-time parameters associated with the operation of the pump and motor components in the hydrostatic propulsion system.

The plurality of sensors 208 includes at least one speed sensor 228 configured to detect the rotational speed of the implement hydraulic pump 219 and/or the left-hand motor 1300 and right-hand motor 1400; at least one temperature sensor 224 configured to detect hydraulic fluid temperature; and at least one pressure sensor 226 configured to detect hydraulic fluid pressure within the propulsion system. The controller 202 receives operational data from the plurality of sensors 208 and determines whether the machine 100 is operating within predefined conditions suitable for valid efficiency estimation. These predefined conditions may include engine speed, pump displacement command, hydraulic fluid temperature above a minimum threshold, and system pressure within a designated operating range. Upon satisfying the operating conditions, the hydraulic monitoring system 600 calculates a volumetric efficiency value for each hydrostatic drive motor by comparing actual hydraulic flow—determined from detected motor speed and estimated displacement—to estimated pump flow based on engine speed, pump displacement, and drive ratio.

The computed volumetric efficiency value for each motor is then compared by the controller 202 to a corresponding efficiency threshold. If the calculated efficiency falls below the threshold, the hydraulic monitoring system 600 generates a system diagnostic output. The system diagnostic output may include an alert via the operator interface 230, a logged diagnostic code, or transmission of the efficiency data to the telematics system 232 for remote monitoring and predictive maintenance planning. If the efficiency remains within acceptable limits, the hydraulic monitoring system 600 continues normal monitoring operations.

In some embodiments, the hydraulic monitoring system 600 continuously assesses the performance of both the left-hand motor 1300 and right-hand motor 1400, and compares their respective efficiency values to identify potential anomalies such as internal leakage, valve malfunctions, or progressive component wear. The system may analyze efficiency deltas between the two motors to detect imbalance or degradation on one side of the hydrostatic drive circuit.

The hydraulic monitoring system 600 enables real-time monitoring and predictive maintenance capabilities for the hydrostatic propulsion system in the machine 100. By utilizing sensor feedback from the plurality of sensors 208, the system can continuously assess volumetric efficiency trends for each motor and pump combination. This data-driven approach supports operational reliability, reduces unplanned downtime, and provides actionable insights for service intervention. The telematics system 232 may further transmit efficiency metrics and alerts for fleet-wide monitoring, allowing centralized diagnostic tracking and long-term performance analysis of hydrostatically driven machines. The telematics system 232 can further transmit efficiency trends to a remote monitoring system for fleet-wide analysis.

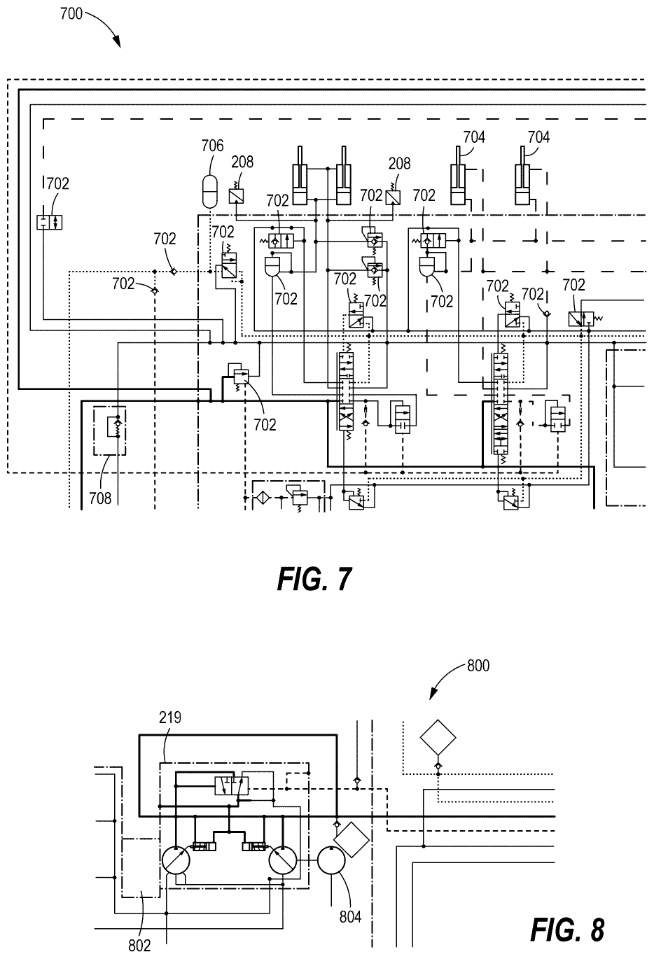

Referring now to FIG. 7, FIG. 7 illustrates a schematic representation of a multi-hydraulic circuit 700 monitored by the hydraulic monitoring system 500 of FIG. 5, according to an embodiment of the present disclosure. The multi-hydraulic circuit 700 comprises a plurality of valves 702, a plurality of cylinders 704, and an accumulator 706, all of which contribute to the efficient operation of hydraulic actuators and control mechanisms within the machine 100. The plurality of valves 702 includes solenoid valves, ball valves, check valves, and relief valves, each serving a specific function for controlling hydraulic flow, pressure regulation, and actuation within the system.

The multi-hydraulic circuit 700 is applicable to both the implement 112 and the steering column 110, allowing for independent yet parallel real-time monitoring of hydraulic efficiency. The hydraulic monitoring system 500 evaluates system efficiency separately for the implement 112 and the steering column 110 by continuously analyzing sensor data collected from the plurality of sensors 208. The cylinder 704 is operatively connected to the plurality of valves 702, enabling controlled movement of hydraulic components based on input from the controller 202. The accumulator 706 stores pressurized hydraulic fluid, ensuring rapid response to actuation commands while also mitigating pressure fluctuations that could affect system efficiency. Additionally, the plurality of sensors 208 includes steering column sensors 210, lift and tilt cylinder position sensor 214, fluid temperature sensor 224, and fluid pressure sensor 226, all of which provide real-time data for monitoring hydraulic efficiency. The sensors continuously relay information to the controller 202, ensuring accurate detection of hydraulic system performance.

Now referring to FIG. 8, FIG. 8 illustrates a schematic representation of a multi-hydraulic implement circuit 800 monitored by the hydraulic monitoring system 500, according to an embodiment of the present disclosure. The multi-hydraulic implement circuit 800 is responsible for managing the hydraulic power distribution for both the implement 112 and the steering column 110, ensuring optimal performance and system longevity. The multi-hydraulic implement circuit 800 includes a torque converter pump drive 802, which transmits mechanical energy to hydraulic pumps, facilitating fluid pressurization and distribution throughout the system, and a transmission gear pump 804. The transmission gear pump 804 supplies hydraulic fluid to support auxiliary machine functions, including lubrication and control of transmission-related circuits, and operates in conjunction with the torque converter pump drive 802 to maintain balanced system pressure under varying load conditions. The control system 200 ensures that real-time adjustments are made to hydraulic parameters based on sensor data, improving overall efficiency and operational reliability. The implement pump 219, fluidly connected within the multi-hydraulic implement circuit 800, is configured to supply pressurized hydraulic fluid to the implement actuator 221, thereby enabling precise actuation of the implement 112 in response to operational demands from the implement control actuator 114 or the joystick 222.

The hydraulic monitoring system 500 continuously evaluates hydraulic efficiency under predefined operational conditions. Efficiency estimation is enabled when the following conditions are met: (1) Engine speed greater than 500 rpm; (2) hydraulic fluid temperature above 20 °C; (3) lift command greater than 5% and tilt command less than 5%, or tilt command greater than 5% and lift command less than 5%; and (4) pump pressure between 10000 kPa and 30000 kPa. In some embodiments, flows not directly contributing to primary actuator movement—such as those associated with ride control systems, accumulator charging, and pilot charge flow—may introduce parasitic losses. These parasitic flows should be estimated separately to ensure the accuracy of volumetric efficiency calculations. Isolating these non-load-related flow components allows the hydraulic monitoring system to more precisely attribute deviations in efficiency to the intended implement or steering hydraulic operations, rather than to background or auxiliary hydraulic functions.

The system calculates implement pump speed using the formulas:

Implement Pump Speed(Pmpspd)=Eng Spd*Drive ratio

Pump flow estimation is determined by averaging the hydraulic displacement and drive ratio over multiple time steps:

$${Pump}_{flow - seg} = \frac{1}{N} {\sum }_{i = 1}^{N} \{ \frac{\begin{matrix}{engine}_{speed} ( i ) * {pump}_{displacement estimation} ( i ) * \\ {pump}_{drive ratio}\end{matrix}}{1000} \}$$

Load flow estimation for the implement or steering column is computed using cylinder bore diameter, stroke position changes, and time increments:

$${Load}_{flow} ( n ) = No of cylinders * Δ {Cyl}_{pos} ( n ) * \frac{π}{4} * {cylinder}_{bore diameter}^{2} * \frac{60}{dt} \times {10}^{- 6}$$

The segment-based average load flow is then computed as:

$${Load}_{flow - seg} = \frac{1}{N} {\sum }_{i = 1}^{N} {Load}_{flow} ( i )$$

as:

$${Efficiency}_{seg} = \frac{{Load}_{flow - seg}}{{Pump}_{flow - seg}} \times 100 \%$$

The efficiency calculation process integrates multiple parameters, including engine speed, pump displacement, drive ratio, cylinder position changes, and hydraulic flow rates. By leveraging real-time sensor data, the hydraulic monitoring system 500 continuously computes and compares the expected versus actual volumetric efficiency, ensuring any significant deviations are detected and addressed promptly. The efficiency segment computation provides a continuous assessment of hydraulic system performance, allowing operators to take corrective actions based on data-driven insights. This proactive approach enhances operational reliability, maintains optimal hydraulic performance, and extends the lifespan of critical hydraulic components in both the implement 112 and the steering column 110.

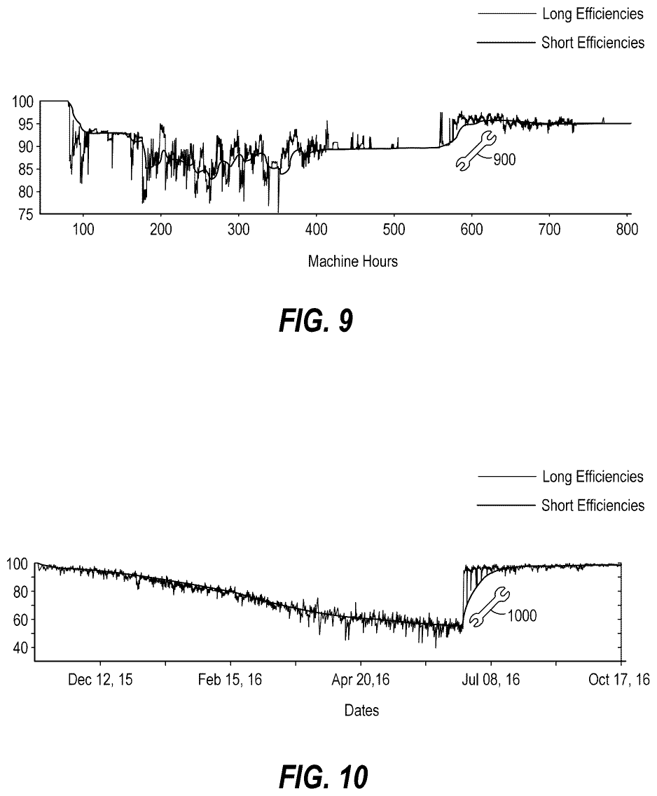

Now referring to FIGS. 9-10, FIG. 9 illustrates an exemplary graph of a system efficiency issue identified by the hydraulic monitoring system 500 of FIG. 5, according to an embodiment of the present disclosure. The graph represents real-time efficiency trends monitored across the implement 112 and the steering column 110, allowing the system to detect deviations from expected operational thresholds. A detected anomaly triggers a system service event 900, indicating potential issues such as improper system adjustment, component wear, or impending failure. The hydraulic monitoring system 500 analyzes deviations in system parameters, including relief valve settings, margin pressure, and pilot pressure, ensuring that any abnormalities are promptly addressed. The efficiency data is processed through telematics system 232, allowing for remote monitoring and predictive maintenance scheduling.

FIG. 10 illustrates an exemplary graph of a pump efficiency failure identified by the hydraulic monitoring system 500 of FIG. 5, according to an embodiment of the present disclosure. The graph visualizes pump performance trends, with efficiency thresholds used to determine when a pump service event 1000 should be triggered. A significant drop in pump efficiency may indicate progressive wear, valve malfunctions, or a critical failure in the hydraulic system. By continuously monitoring the hydraulic pump's volumetric efficiency and comparing actual versus expected flow rates, the hydraulic monitoring system 500 provides early warnings of component degradation. This data allows operators to take proactive maintenance measures, reducing downtime and preventing system failures before they impact machine performance.

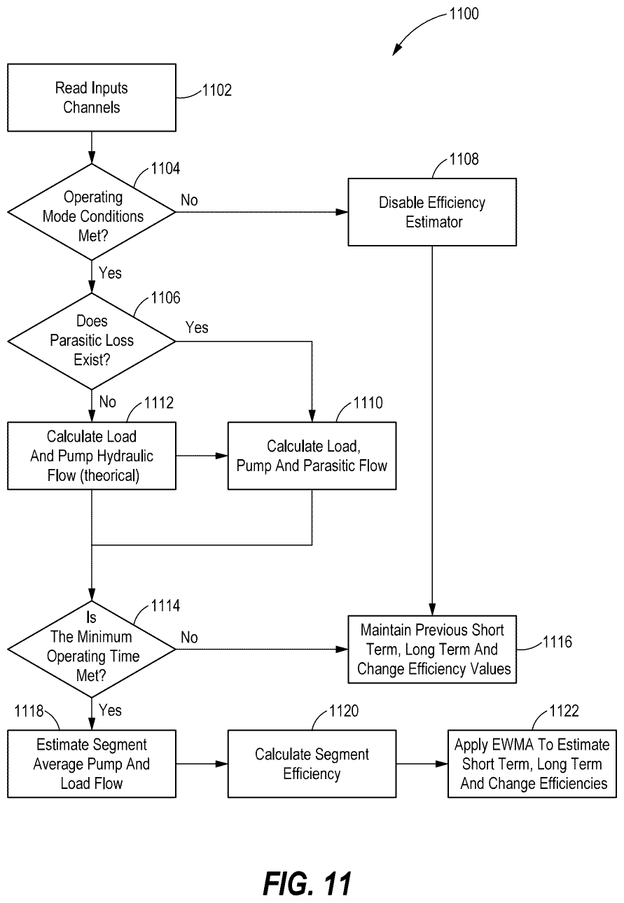

Now referring to FIG. 11, FIG. 11 illustrates an operation flowchart of the health monitoring system 500 of FIG. 5, according to an embodiment of the present disclosure. The monitoring operation 1100 begins with operation 1102, where the health monitoring system 500 reads channel inputs from the plurality of sensors 208, including pressure, flow, and temperature data from the steering column 110 and the implement 112. The health monitoring system 500 then proceeds to operation 1104, where it determines whether the operating mode conditions are met based on predefined parameters such as engine speed, fluid temperature, and hydraulic pressure. If the conditions are not satisfied, the health monitoring system 500 proceeds to operation 1108, where the efficiency estimator is disabled, and the health monitoring system 500 maintains previous efficiency values until valid conditions are detected.

If the operating mode conditions are met at operation 1104, the process advances to operation 1106, where the health monitoring system 500 evaluates whether a parasitic flow calculation is required. If a parasitic flow calculation is required, the health monitoring system 500 proceeds to operation 1110, where it calculates the theoretical load, pump, and parasitic flow. If the parasitic flow calculation is not required, the health monitoring system 500 instead advances to operation 1112, where it calculates only the theoretical load and hydrostatic flow. Both operations 1110 and 1112 lead to operation 1114, where the health monitoring system 500 checks if the minimum operating time has been met to ensure stable efficiency calculations. If the minimum time is not satisfied, the health monitoring system 500 moves to operation 1116, maintaining previous short-term, long-term, and efficiency change values without updating the estimation.

Once the minimum operating time condition is met at operation 1114, the process advances to operation 1118, where the health monitoring system 500 estimates the segment average pump and load flow based on real-time data. In operation 1120, the health monitoring system 500 computes segment efficiency by comparing measured flow values against theoretical expectations, accounting for hydraulic losses or inefficiencies. Finally, the health monitoring system 500 proceeds to operation 1122, where the exponentially weighted moving average (EWMA) algorithm is applied to estimate short-term, long-term, and efficiency trend changes, ensuring continuous assessment of hydraulic system health. The EWMA algorithm, as generally known in the arts, assigns exponentially decreasing weights to older data points, thereby emphasizing recent measurements while retaining historical context to effectively track gradual performance trends and detect emerging anomalies.

The health monitoring system 500 integrates real-time operational data collected from FIG. 5's hydraulic monitoring system, FIG. 7's multi-hydraulic circuit 700, and FIG. 8's multi-hydraulic implement circuit 800 to detect deviations indicative of system degradation, wear-out, or impending failure in the implement 112 and the steering column 110. Efficiency trends displayed in FIGS. 9-10 further aid in diagnosing early-stage hydraulic performance issues, allowing operators to take corrective actions before system failures occur. By leveraging data from multiple sources, the health monitoring system 500 enhances machine reliability, optimizes maintenance strategies, and prevents costly downtime.

During machine operation, the control system 200 and implement controller 206 continuously monitor operational parameters from the plurality of sensors 208 to determine conditions suitable for calculating Implement System Efficiency. Implement System Efficiency calculations are only performed for valid lift or tilt segments, where such segments are identified based on predefined operational criteria.

A lift segment is initiated when all of the following conditions are satisfied: the lift valve command exceeds a segment minimum valve command threshold (Seg_min_vlv_cmd), the absolute value of the tilt valve command remains below a maximum valve command threshold (Seg_max_vlv_cmd), the implement pump pressure (as detected by implement pump sensor 220) falls within a predefined operational range between minimum implement pump pressure (Min_impl_pump_pressure) and a maximum implement pump pressure (Max_impl_pump_pressure), the hydraulic fluid temperature (measured by fluid temperature sensor 224) exceeds a minimum hydraulic fluid temperature threshold (Min_hyd_oil_temp), the actual engine speed (monitored by speed sensor 228) exceeds a minimum engine speed threshold (Min_Engine_speed), and the lift cylinder speed (derived from the lift & tilt cylinder position sensor 214) exceeds a minimum cylinder velocity threshold (Min_cyl_vel).

Similarly, a tilt segment is initiated when all of the following conditions are satisfied: the tilt valve command exceeds the segment minimum valve command threshold (Seg_min_vlv_cmd), the absolute value of the lift valve command remains below the segment maximum valve command threshold (Seg_max_vlv_cmd), the implement pump pressure falls within the defined operational range between Min_impl_pump_pressure and Max_impl_pump_pressure, the hydraulic fluid temperature exceeds Min_hyd_oil_temp, the actual engine speed exceeds Min_Engine_speed, and the tilt cylinder velocity exceeds Min_cyl_vel

A lift or tilt segment terminates when any of the above conditions are no longer satisfied. These conditions collectively define stable operating events for reliable efficiency calculations. A segment is further validated by ensuring the flow conditions meet the following criteria: (1) hydraulic flow is predominantly directed either to the lift cylinders or to the tilt cylinders, minimizing cross-flow; (2) implement pump discharge pressure is within a target range that reflects loaded bucket conditions, avoiding both excessively high relief pressure conditions and excessively low pressures that would adversely impact volumetric efficiency; (3) engine speed remains above a threshold to maintain acceptable pump efficiency; and (4) hydraulic fluid temperature is maintained within the optimal operating range to ensure proper fluid viscosity and seal performance.

Each detected segment is tracked by a segment timer (t_seg), which measures the duration from segment initiation to termination. Only segments with a duration greater than a configurable minimum segment duration (Seg_min_duration), which defaults to 3 seconds, are considered valid for Implement System Efficiency calculations. Segments shorter than this duration are excluded to filter out transient startup and shutdown effects.

If any required sensor, including the lift & tilt cylinder position sensor 214, fluid temperature sensor 224, fluid pressure sensor 226, or implement pump sensor 220, reports a fault condition, segment detection and efficiency calculations are temporarily paused until the fault is cleared.

Once a valid segment is identified, the average Implement System Efficiency is calculated for the duration of the segment. From the segment start, the controller 202 records lift or tilt cylinder positions at each sample time, and the incremental cylinder movement (ACyl pos) is calculated as the difference between consecutive position samples.

ΔCylₚₒₛ(n)=cylinderₚₒₛ(n)−cylinderₚₒₛ(n−1)

The actual hydraulic load flow (Load_flow) for each sample is computed using the number of cylinders, the incremental cylinder position, cylinder bore diameter, and the sample time interval (dt), according to the formula:

$${Load}_{flow} ( n ) = No of cylinders * Δ {Cyl}_{pos} ( n ) * \frac{π}{4} * {cylinder}_{bore diameter}^{2} * \frac{60}{dt} \times {10}^{- 6}$$

To estimate pump displacement, the control system 200 references stored flow maps correlated to the current tilt and lift valve commands, selecting the larger of the two values for each sample, and capping the result at the maximum allowable pump displacement.

pump_{displacement estimation}(i)=max(map(tilt_{CMDvalve}),map(lift_{CMDvalve}))

The cumulative average load flow and pump flow for the segment are calculated as follows:

$${Load}_{flow - seg} = \frac{1}{N} {\sum }_{i = 1}^{N} {Load}_{flow} ( i )$$

$${Pump}_{flow - seg} = \frac{1}{N} {\sum }_{i = 1}^{N} \{ \frac{\begin{matrix}{engine}_{speed} ( i ) * {pump}_{displacement estimation} ( i ) * \\ {pump}_{drive ratio}\end{matrix}}{1000} \}$$

Where N represents the number of samples in the segment. The segment volumetric efficiency (Efficiency_seg) is then computed as:

$${Efficiency}_{seg} = \frac{{Load}_{flow - seg}}{{Pump}_{flow - seg}} \times 100 \%$$

Upon initialization of a blank electronic control module (ECM), default values for segment average Implement System Efficiency (95%), long-term average efficiency (100%), and short-term average efficiency (100%) are preloaded. These default values are excluded from moving average calculations once valid segment data becomes available.

Only segment efficiencies within the range of 0% to 100% are considered valid for the moving average calculations. Segment efficiencies exceeding 100% are capped at 100%, and segment efficiencies below 0% are discarded to prevent erroneous data from skewing long-term efficiency calculations. This filtering process ensures that outlier data does not adversely affect the ongoing health monitoring and predictive maintenance algorithms executed by the hydraulic monitoring system 500 and the controller 202.

### Hystat Machine Health Efficiency Monitoring

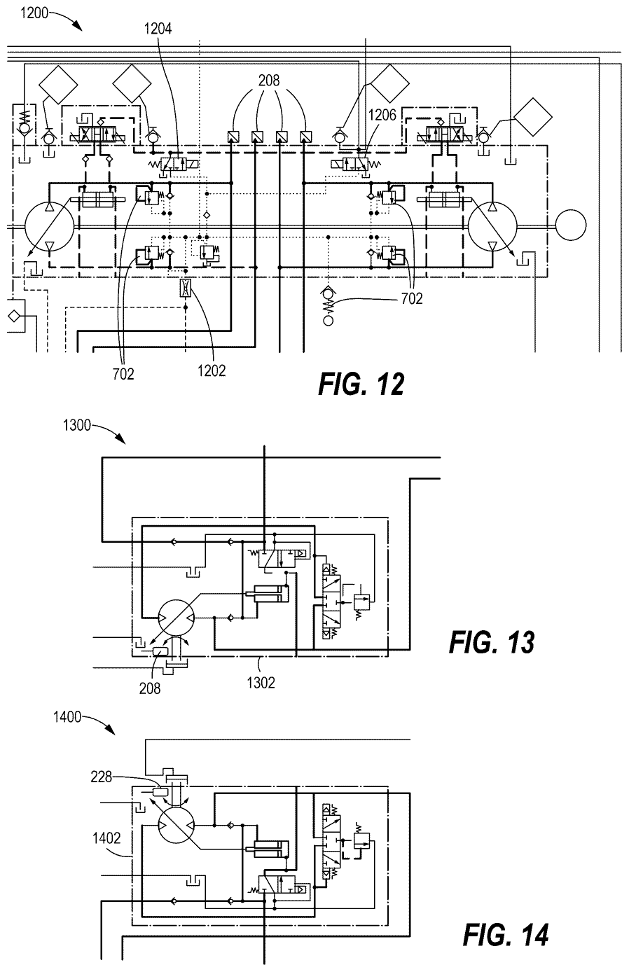

Referring now to FIG. 12, a schematic representation of a multi-hydraulic hystat pump circuit 1200 is illustrated, showing its integration with the hydraulic monitoring system 600 of FIG. 6 for monitoring and evaluating the efficiency of the hydrostatic propulsion system incorporated in the machine 100 of FIG. 1, according to another embodiment of the present disclosure. The multi-hydraulic hystat pump circuit 1200 facilitates hydraulic fluid flow, pressure regulation, and controlled activation of various hydraulic components within the hystat propulsion system, ensuring efficient propulsion and braking performance.

The multi-hydraulic hystat pump circuit 1200 includes a plurality of valves 702, which are configured to direct hydraulic fluid flow and regulate pressure during machine propulsion and braking operations. The plurality of valves 702 includes solenoid valves, ball valves, check valves, and relief valves, each contributing to controlled distribution and flow management of hydraulic fluid within the hystat propulsion system. These valves interact with various fluid pathways and are selectively actuated based on real-time operational feedback received by the controller 202.

An orifice 1202 is provided within the multi-hydraulic hystat pump circuit 1200, and is configured to restrict and regulate hydraulic fluid flow under specific operating conditions. The orifice 1202 helps to maintain targeted flow rates, enabling stable fluid control within the hydraulic loop, and supporting efficient propulsion system response under variable load conditions.

The multi-hydraulic hystat pump circuit 1200 further includes a hystat cutoff 1204, which functions to isolate or disengage hydraulic fluid flow to certain components within the hystat propulsion system when specific conditions are detected by the controller 202 or the hydraulic monitoring system 600. The hystat cutoff 1204 ensures rapid system isolation to protect sensitive hydraulic components, reduce unnecessary hydraulic loading, and improve overall efficiency and system responsiveness during transitional operating states.

A brake release 1206 is also provided within the multi-hydraulic hystat pump circuit 1200. The brake release 1206 is configured to actuate hydraulic pressure release to disengage the machine braking components, enabling smooth transitions between stationary and propulsion states. The brake release 1206 operates in coordination with the plurality of valves 702 to regulate pressure buildup and release within the braking circuit, ensuring controlled and responsive machine braking and release functionality.

The hydraulic monitoring system 600 continuously acquires data from the plurality of sensors 208 positioned throughout the multi-hydraulic hystat pump circuit 1200, including the fluid temperature sensor 224, the fluid pressure sensor 226, and speed sensor 228. Real-time hydraulic fluid conditions, including pressure, temperature, and flow rates, are transmitted to the controller 202, where the data is analyzed to compute volumetric efficiency and detect potential deviations indicative of hydraulic performance degradation.

The hydraulic monitoring system 600 evaluates the efficiency of the multi-hydraulic hystat pump circuit 1200 by comparing actual hydraulic flow rates to expected values, which are derived based on the displacement of the implement hydraulic pump 219, the engine 106 speed, and the current state of the plurality of valves 702. If efficiency calculations indicate a drop below a predefined threshold, the controller 202 triggers an efficiency alert via the operator interface 230 and transmits diagnostic data to the telematics system 232 for remote monitoring and predictive maintenance.

By integrating the multi-hydraulic hystat pump circuit 1200 with real-time efficiency monitoring through the hydraulic monitoring system 600, the machine 100 benefits from improved hystat propulsion system reliability, reduced downtime, and extended service life of critical hydraulic components. The combination of plurality of valves 702, orifice 1202, hystat cutoff 1204, and brake release 1206 ensures that the multi-hydraulic hystat pump circuit 1200 can adaptively manage hydraulic flow and pressure to maintain optimal machine performance across varied operating conditions.

Referring now to FIG. 13, a schematic representation of a left-hand motor 1300 is illustrated, according to an embodiment of the present disclosure. Similarly, referring now to FIG. 14, a schematic representation of a right-hand motor 1400 is illustrated, according to an embodiment of the present disclosure. The left-hand motor 1300 and right-hand motor 1400 are each provided in the hystat propulsion system of the machine 100 of FIG. 1, where they independently drive the ground engaging elements 104 on the left and right sides of the machine 100, respectively.

Each of the left-hand motor 1300 and right-hand motor 1400 is communicatively monitored by the hydraulic monitoring system 600 described in FIG. 6. Each motor includes a respective speed sensor 228, configured to detect rotational speed of the motor shaft. The detected speed data is transmitted to the controller 202, where it is processed along with hydraulic pressure data from the fluid pressure sensor 226 and hydraulic temperature data from the fluid temperature sensor 224 to calculate the volumetric efficiency of each motor.

The left-hand motor 1300 and right-hand motor 1400 each receive hydraulic fluid from the multi-hydraulic hystat pump circuit 1200 of FIG. 12, with fluid flow and pressure regulated by the plurality of valves 702. This ensures balanced hydraulic delivery to each motor during normal operation. The hydraulic monitoring system 600, using data from the plurality of sensors 208, continuously evaluates the volumetric efficiency of the left-hand motor 1300 and right-hand motor 1400 by comparing actual flow and speed data to expected performance parameters. If the efficiency of either motor drops below a predefined threshold, the controller 202 triggers an efficiency alert via the operator interface 230 and logs the event in the telematics system 232 for remote diagnostics and predictive maintenance.

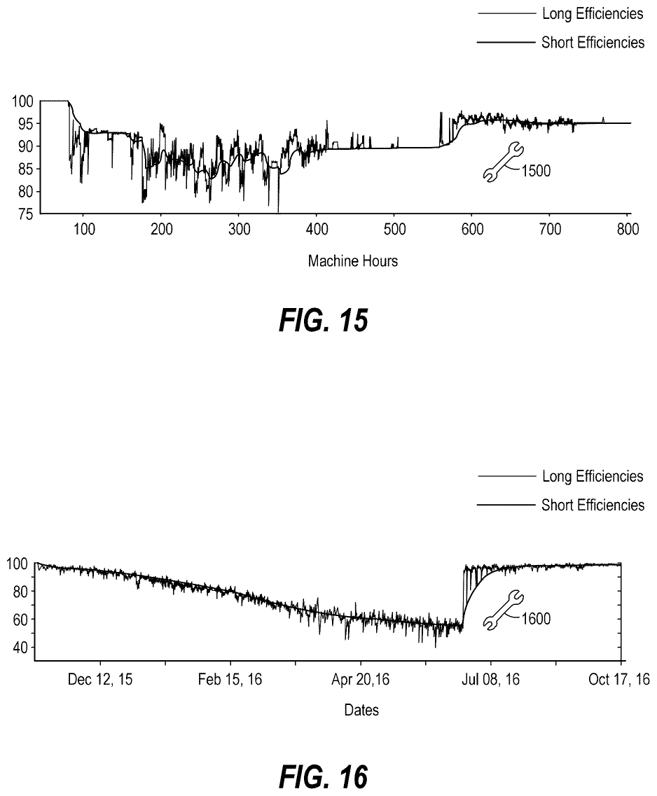

Referring now to FIG. 15, an exemplary graph is shown illustrating a hystat system service event 1500 identified by the hydraulic monitoring system 600 of FIG. 6, according to an embodiment of the present disclosure. The hystat system service event 1500 graphically represents detected efficiency trends associated with the implement 112 and the steering column 110, enabling early identification of hydraulic efficiency deviations. These deviations may indicate conditions such as out-of-adjustment settings in the plurality of valves 702 (including relief valve settings, margin pressure, or pilot pressure), progressive component wear-out within the implement control actuator 114 or steering actuator 216, or a potential failure in the implement hydraulic pump 219, the steering hydraulic pump 218, or other hydraulic elements.

Referring now to FIG. 16, an exemplary graph is shown illustrating a hystat pump service event 1600, according to an embodiment of the present disclosure. The hystat pump service event 1600 is generated by the hydraulic monitoring system 600 when volumetric efficiency calculations for the implement hydraulic pump 219 or steering hydraulic pump 218 fall below predefined efficiency thresholds. The hystat pump service event 1600 provides real-time visual representation of declining pump efficiency, enabling predictive detection of pump wear, internal leakage, or valve performance degradation.

Both the hystat system service event 1500 and the hystat pump service event 1600 are transmitted to the operator interface 230 to notify machine operators and are logged by the telematics system 232 for remote analysis, predictive maintenance planning, and fleet-wide health tracking.

The hydraulic monitoring system 600 continuously evaluates the operational health of the hystat propulsion system of the machine 100 by calculating hystat system efficiency for each independent drive circuit, including the left-hand [symbol] ensure accuracy, hystat system efficiency estimation is only enabled when specific operating conditions are satisfied. These conditions include the engine 106 operating at a speed greater than 800 revolutions per minute (rpm), hydraulic fluid temperature sensor 224 reading above 20 degrees Celsius, and the hydraulic pump command exceeding 5% displacement. Additionally, the fluid pressure sensor 226 must detect a hydraulic pressure within a predefined range to confirm proper load conditions.

When these conditions are met, the controller 202 calculates the rotational speed of each hydraulic pump in the multi-hydraulic hystat pump circuit 1200. Specifically, the hystat pump speed (Pmp_spd) is determined as:

$${Pump}_{flow - seg} = \frac{1}{N} {\sum }_{i = 1}^{N} \{ \frac{\begin{matrix}{engine}_{speed} ( i ) * {pump}_{displacement estimation} ( i ) * \\ {pump}_{drive ratio}\end{matrix}}{1000} \}$$

This calculation links the rotational speed of the engine 106 to the hydraulic pump output, factoring in the drive ratio specific to the drivetrain configuration.

To determine actual hydraulic flow supplied by the pump, the controller 202 calculates a segment-based pump flow (Pump_flow−seg), which averages the calculated flow rate over a series of time steps. The formula for segment-based pump flow is:

$${Load}_{flow} ( n ) = \frac{1}{N} {\sum }_{i = 1}^{N} \{ \frac{{Motor}_{speed} ( i ) * {Motor}_{displacement estimation} ( i )}{1000} \}$$

The controller 202 also calculates the hydraulic fluid flow delivered to the instantaneous load flow (Load_flow) is calculated for each motor using the motor's rotational speed and estimated displacement at each time step:

$${Load}_{flow - seg} = \frac{1}{N} {\sum }_{i = 1}^{N} {Load}_{flow} ( i )$$

With both segment-based pump flow and segment-based load flow calculated, the hydraulic monitoring system 600 determines the hystat system efficiency for each motor and pump combination. This efficiency, expressed as a percentage, is the ratio of load flow to pump flow for the given segment:

$${Efficiency}_{seg} = \frac{{Load}_{flow - seg}}{{Pump}_{flow - seg}} \times 100 \%$$

The calculated efficiency_seg is continuously compared to predefined efficiency thresholds stored in the controller 202. If the efficiency of either the left-hand motor 1300 or the right-hand motor 1400 falls below the acceptable range, the at pump service event 1600, as appropriate. These events are displayed on the operator interface 230 and logged in the telematics system 232 for remote diagnostics and predictive maintenance.

This real-time efficiency monitoring and calculation process enables the machine 100 to proactively detect developing issues such as pump wear, motor internal leakage, or improper valve settings within the plurality of valves 702, ensuring the long-term reliability and performance of the hystat propulsion system.

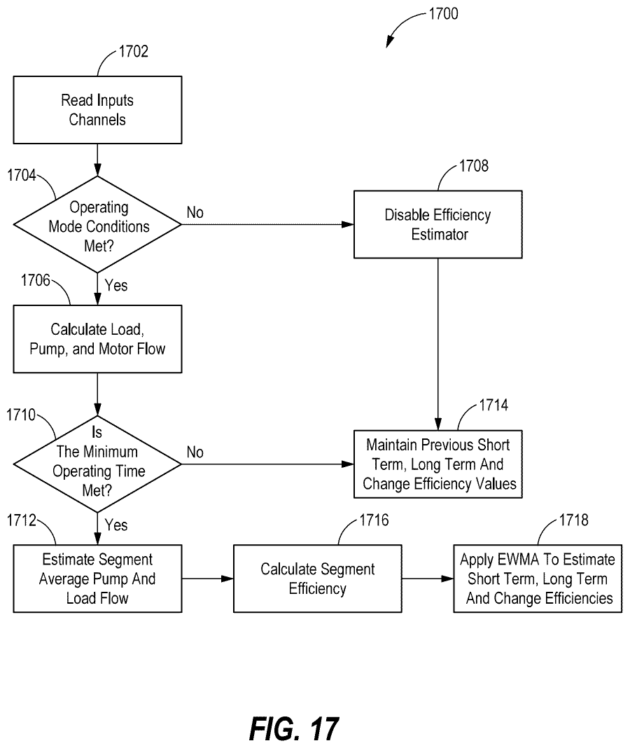

Referring now to FIG. 17, a schematic representation of an operation flowchart illustrating a hystat monitoring operation 1700 performed by the hydraulic monitoring system 600 of FIG. 6 is shown, according to another embodiment of the present disclosure. The hystat monitoring operation 1700 governs the sequence of operations used by the controller 202 to monitor and evaluate the hydraulic efficiency of the hystat propulsion system provided in the machine 100.

The hystat monitoring operation 1700 begins with operation 1702, where the controller 202 reads data from the plurality of sensors 208 distributed throughout the hystat propulsion system, including data from the speed sensor 228, the fluid pressure sensor 226, the fluid temperature sensor 224, and sensors associated with the left-hand motor 1300 and right-hand motor 1400.

Following data acquisition, operation 1704 evaluates whether the predefined operating mode conditions are met. These conditions include verifying that the engine 106 speed exceeds a threshold (e.g., 800 rpm), the fluid temperature sensor 224 detects temperatures greater than 20 degrees Celsius, and that the hydraulic pump command exceeds 5% displacement. In addition, the fluid pressure sensor 226 must detect hydraulic pressure within a predefined range. If all operating mode conditions are met, the hystat monitoring operation 1700 proceeds to operation 1706. If the conditions are not satisfied, the process advances to operation 1708.

In operation 1706, the controller 202 calculates theoretical hydraulic flow for the motor flow of the left-hand motor 1300 and right-hand motor 1400, accounting for pump displacement, motor displacement, and speed sensor 228 feedback. These theoretical flow rates represent expected volumetric performance based on current operating conditions and are used for evaluating actual efficiency.

If the operating mode conditions were not met, operation 1708 disables the efficiency estimation process, preventing inaccurate efficiency values from being calculated under non-standard conditions. The process then proceeds directly to operation 1714 to preserve previously calculated efficiency values.

At operation 1710, the controller 202 checks whether the minimum required operating time has been reached. This minimum time ensures that short bursts of transient data do not skew the efficiency calculations. If the minimum time has not been satisfied, the process advances to operation 1714 to maintain previously calculated short-term and long-term efficiency values, along with the change in efficiency. If the minimum operating time has been met, the process advances to operation 1712.

At operation 1712, the controller 202 calculates the segment average pump flow and segment average load flow, using the methodologies described in connection with the hydraulic monitoring system 600 and hystat system efficiency calculations. These values represent the average hydraulic flow supplied by the implement hydraulic pump 219 and steering hydraulic pump 218 compared to the actual hydraulic flow consumed by the left-hand motor 1300 and right-hand motor 1400 over the current measurement segment.

In operation 1716, the controller 202 calculates the segment efficiency by comparing the calculated segment average load flow to the segment average pump flow, providing a real-time efficiency value that reflects actual operating performance.

Finally, in operation 1718, the controller 202 applies an Exponentially Weighted Moving Average (EWMA) algorithm to estimate updated short-term efficiency, long-term efficiency, and efficiency change rate. These calculated trends allow the hydraulic monitoring system 600 to track performance degradation over time, predict potential failures, and trigger hystat system service event 1500 or hystat pump service event 1600 when efficiency trends deviate beyond acceptable thresholds. The EWMA algorithm, as generally known by a person skilled in the art, progressively reduces the influence of older efficiency measurements by applying exponential weighting, thus enabling the controller 202 to more sensitively detect recent changes in system performance while maintaining a stable baseline for long-term trend analysis.

The hystat monitoring operation 1700 repeats continuously during machine operation, ensuring real-time hydraulic efficiency monitoring and predictive health assessment for both the left-hand motor 1300, right-hand motor 1400, implement hydraulic pump 291, and steering hydraulic pump 218, providing the operator with continuous feedback via the operator interface 230 and remote analysis capabilities through the telematics system 232.

### INDUSTRIAL APPLICABILITY

In operation, the present disclosure may find applicability in many industries including, but not limited to, the automotive, construction, earth-moving, mining, and agricultural industries. Specifically, the systems, machines, and methods of the present disclosure may be used for monitoring health status of hydraulic systems in machines including, but not limited to, excavators, backhoes, rope shovels, skid steers, wheel loaders, tractors, and similar machines with non-hauling operations for various operator movements relative to movements of machine components. While the foregoing detailed description is made with specific reference to wheel loaders, it is to be understood that its teachings may also be applied onto the other machines such as excavators, draglines, skid steers, rope shovels, backhoes, and the like.

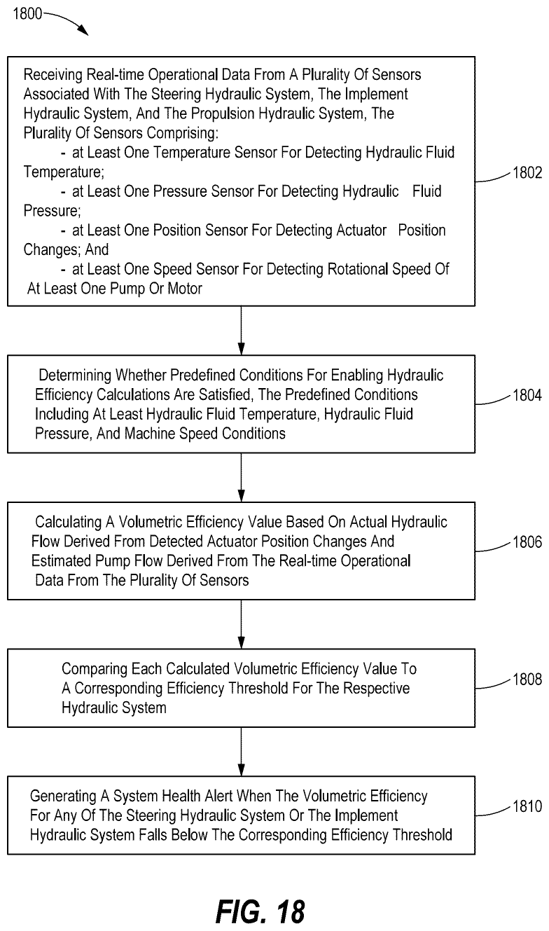

Now referring to FIG. 18, a method 1800 for monitoring the health of hydraulic systems in a machine is illustrated. The machine includes an engine 106, a steering column 110 with a steering hydraulic system, and an implement 112 with an implement hydraulic system. The method 1800 begins at step 1802, where a controller 202 receives real-time operational data from a plurality of sensors 208 distributed across various machine components. The plurality of sensors 208 include at least one temperature sensor 224 for detecting hydraulic fluid temperature, at least one pressure sensor 226 for detecting hydraulic fluid pressure, at least one lift and tilt cylinder position sensor 214 for detecting cylinder actuator position changes, and at least one speed sensor 228 for detecting engine speed. The controller 202 processes data from these sensors to evaluate hydraulic performance. The lift and tilt cylinder position sensor 214 detects the current actuator position, and the controller 202 calculates position changes over time to derive movement data for evaluating hydraulic flow characteristics and efficiency.

At step 1804, the controller 202 determines whether predefined conditions for enabling hydraulic efficiency calculations are satisfied. These predefined conditions include at least hydraulic fluid temperature, hydraulic fluid pressure, and machine speed conditions. The controller 202 verifies that the operational conditions fall within expected ranges before proceeding with efficiency calculations.

At step 1806, the controller 202 calculates a volumetric efficiency value for each hydraulic system, including the steering hydraulic system and the implement hydraulic system. The volumetric efficiency value is determined by analyzing an actual hydraulic flow rate, derived from detected cylinder actuator position changes, and comparing it to an estimated pump flow rate, which is based on engine speed and hydraulic pump displacement. The controller 202 determines changes in actuator position by analyzing time-stamped readings from the position sensor 214, using these values to compute actual hydraulic flow rates for comparison against estimated pump outputs in efficiency calculations.

At step 1808, the controller 202 compares the calculated volumetric efficiency value to a corresponding efficiency threshold for each hydraulic system. This comparison allows for identifying deviations in efficiency that may indicate hydraulic degradation, leaks, or performance inefficiencies. At step 1810, the controller 202 generates a system diagnostic output (“system health alert”) when the volumetric efficiency of the steering hydraulic system, the implement hydraulic system, or any other monitored hydraulic system in the machine falls below its corresponding efficiency threshold. The system diagnostic output may be presented via the operator interface 230, stored for predictive maintenance analysis, or used to trigger an alert to indicate a required service intervention.

The method 1800 enables real-time monitoring of hydraulic system performance, allowing for early detection of efficiency losses and maintenance needs. The integration of the plurality of sensors 208, the controller 202, and predefined efficiency evaluation criteria ensures that the steering hydraulic system, the implement hydraulic system, and hydrostatic systems operate within expected parameters, minimizing downtime and improving operational efficiency across various machine applications

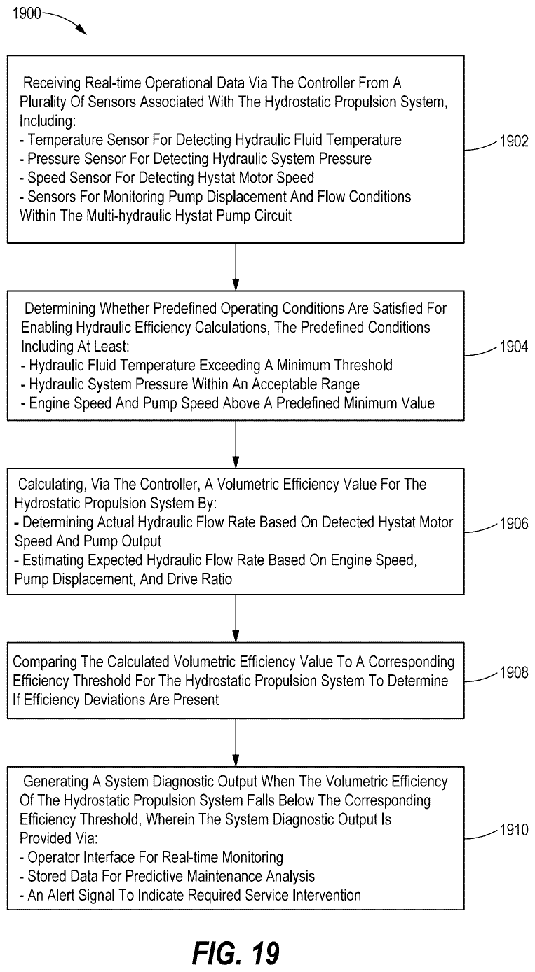

Now referring to FIG. 19, a method 1900 for monitoring the health of a hydrostatic propulsion system in a machine is illustrated. The machine includes an engine 106, a hydraulic propulsion system, and ground-engaging elements 104 powered by hydraulic motors 1300, 1400. The method 1900 begins at step 1902, where a controller 202 receives real-time operational data from a plurality of sensors 208 associated with the hydrostatic propulsion system. These sensors include at least one temperature sensor 224 for detecting hydraulic fluid temperature, at least one pressure sensor 226 for detecting hydraulic system pressure, at least one speed sensor 228 for detecting hystat motor speed, and sensors for monitoring pump displacement and flow conditions within the multi-hydraulic hystat pump circuit 1200.

At step 1904, the controller 202 determines whether predefined operating conditions for efficiency monitoring are met. These predefined conditions include hydraulic fluid temperature, system pressure, and pump speed thresholds, ensuring that efficiency calculations are performed only when the machine is operating under normal conditions.

At step 1906, the controller 202 calculates a volumetric efficiency value for the hydrostatic propulsion system by determining an actual hydraulic flow rate, derived from detected hystat motor speed and pump output, and comparing it to an expected hydraulic flow rate, estimated based on engine speed, pump displacement, and drive ratio.

At step 1908, the controller 202 compares the calculated volumetric efficiency value to a corresponding efficiency threshold for the hydrostatic propulsion system, identifying deviations that may indicate pump wear, internal leakage, or hydraulic degradation.

At step 1910, the controller 202 generates a system diagnostic output when the volumetric efficiency of the hydrostatic propulsion system falls below the corresponding efficiency threshold. The diagnostic output may be displayed via the operator interface 230, stored for predictive maintenance, or used to trigger an efficiency-related alert.

The method 1900 enables continuous evaluation of hydrostatic propulsion system efficiency, ensuring that hydraulic pumps 1200 and hydraulic motors 1300, 1400 operate within expected parameters. By analyzing real-time sensor data, the system can detect efficiency losses, support proactive maintenance decisions, and optimize machine performance across various operating conditions.

From the foregoing, the technology disclosed herein has industrial applicability in a variety of settings such as, but not limited to construction, mining, and agricultural industries that utilize machines such as excavators, backhoes, rope shovels, skid steers, wheel loaders, tractors, and similar machines having work implements for non-hauling operations.

1-20. (canceled)

21. A monitoring system for a hydraulic apparatus, the monitoring system comprising:
a sensor configured to determine sensor data associated with the hydraulic apparatus; and
a controller connected to the sensor, the controller configured to:
receive the sensor data from the sensor during operation of the hydraulic apparatus;
determine a stable condition for the hydraulic apparatus based on the sensor data, wherein in the stable condition is associated with a condition being met, by a component of the hydraulic apparatus, for a time period;
determine a volumetric efficiency in response to the stable condition over the time period;
determine a difference between the volumetric efficiency and a reference efficiency; and
generate a diagnostic output in response to the difference being greater than a threshold value, the diagnostic output identifying a subset of the hydraulic apparatus and including an automated maintenance scheduling output for performing service on the subset of the hydraulic apparatus.

22. The monitoring system of claim 21, wherein the condition for the stable condition includes at least a hydraulic fluid temperature condition, a hydraulic fluid pressure condition, and a speed condition for a machine component associated with the hydraulic apparatus.

23. The monitoring system of claim 21, wherein the stable condition is determined in response to detecting that a hydraulic flow is directed to a single actuator of the hydraulic apparatus.

24. The monitoring system of claim 21, wherein the controller is configured to determine the volumetric efficiency by determining:
an actual hydraulic flow rate based on detected actuator position changes, and
a pump flow rate based on a rotational speed and a hydraulic pump displacement.

25. The monitoring system of claim 21, wherein the controller is further configured to adjust the volumetric efficiency based on whether a parasitic loss condition exists.

26. The monitoring system of claim 21, wherein the controller being configured to determine the difference between the volumetric efficiency and the reference efficiency comprises applying an exponentially weighted moving average (EWMA) to adjust the volumetric efficiency based on a historical efficiency trend.

27. The monitoring system of claim 21, further comprising an operator interface configured to display the diagnostic output in response to the difference being greater than the threshold value and wherein the diagnostic output is further transmitted by a telematics system to a remote monitoring system configured for monitoring a fleet of machines.

28. A work machine comprising:
a frame;
an engine mounted on the frame;
a ground engaging element supporting the frame;
a hydraulic system; and
a monitoring system configured to:
receive sensor data from a sensor associated with the hydraulic system during operation of the work machine;
determine a stable condition for the hydraulic system based on the sensor data, wherein the stable condition is associated with a condition being met for a component of the hydraulic system for a period of time;
determine a volumetric efficiency in response to the stable condition over the period of time;
determine a difference between the volumetric efficiency and a reference efficiency; and
generate a diagnostic output in response to the difference being greater than a threshold value, the diagnostic output identifying a subset of the hydraulic system and including an automated maintenance scheduling output for performing service on the subset of the hydraulic system.

29. The work machine of claim 28, wherein the condition for the stable condition include at least a hydraulic fluid temperature condition, a hydraulic fluid pressure condition, and a machine component speed condition.

30. The work machine of claim 28, wherein the stable condition is determined in response to detecting that a hydraulic flow is directed to a single actuator of the hydraulic system.

31. The work machine of claim 28, wherein the monitoring system is configured to determine the volumetric efficiency by determining:
an actual hydraulic flow rate based on detected actuator position changes; and
a pump flow rate based on engine speed and hydraulic pump displacement.

32. The work machine of claim 28, wherein the monitoring system is further configured to adjust the volumetric efficiency based on whether a parasitic flow loss condition exists.

33. The work machine of claim 28, wherein the monitoring system is further configured to determine the difference between the volumetric efficiency and the reference efficiency comprises applying an exponentially weighted moving average (EWMA) to adjust the volumetric efficiency based on a historical efficiency trend.

34. The work machine of claim 28, further comprising an operator interface configured to display the diagnostic output in response to the difference being greater than the threshold value and wherein the diagnostic output is further transmitted by a telematics system to a remote monitoring system configured for monitoring a fleet of machines.

35. A method for monitoring a hydraulic system, the method comprising:
receiving sensor data from a sensor associated with the hydraulic system during operation of the hydraulic system;
determining a stable condition for the hydraulic system based on the sensor data, wherein the stable condition is associated with a condition being met for a component of the hydraulic system for a time period;
determining a volumetric efficiency in response to the stable condition over the time period;
determining a difference between the volumetric efficiency and a reference efficiency; and
generating a diagnostic output in response to the difference being greater than a threshold value, the diagnostic output identifying a subset of the hydraulic system and including an automated maintenance scheduling output for performing service on the subset of the hydraulic system.

36. The method of claim 35, wherein the condition for the stable condition includes at least a hydraulic fluid temperature condition, a hydraulic fluid pressure condition, and a machine component speed condition.

37. The method of claim 35, wherein the stable condition is determined in response to detecting that a hydraulic flow is directed to a single actuator of the hydraulic system.

38. The method of claim 35, wherein determining the volumetric efficiency comprises determining an actual hydraulic flow rate based on detected actuator position changes and determining a pump flow rate based on a rotational speed and a hydraulic pump displacement.

39. The method of claim 35, further comprising adjusting the volumetric efficiency based on whether a parasitic loss condition is met.

40. The method of claim 35, wherein determining the difference between the volumetric efficiency and the reference efficiency comprises applying an exponentially weighted moving average (EWMA) to adjust the volumetric efficiency based on a historical efficiency trend.
